(19) United States
(12) Patent Application Publication
(10) Pub. No.: US 2026/0246373 A1
(43) Pub. Date: Aug. 20, 2026

(54) POWER FACTOR CORRECTION CIRCUIT AND CONTROL METHOD THEREOF

(71) Applicant: Delta Electronics (Thailand) Public Company Limited, Samutprakarn (TH)

(72) Inventors: Yuhua Hu, Shanghai (CN); Min Xu, Shanghai (CN); Jianliang Lin, Shanghai (CN); Hui Huang, Shanghai (CN); Kai Dong, Shanghai (CN)

(21) Appl. No.: 19/260,120

(22) Filed: Jul. 3, 2025

(30) Foreign Application Priority Data
Feb. 18, 2025 (CN) 202510180430.4

(51) Int. Cl. H02M 1/42; H02M 7/217

(52) U.S. Cl. CPC H02M 1/4208; H02M 7/217

(57) ABSTRACT

A power factor correction circuit includes an inductor, a first upper switch and a first lower switch. The first lower switch and the first upper switch are respectively served as a main switch and a rectifier switch when an input voltage has a positive amplitude. The first upper switch and the first lower switch are respectively served as the main switch and the rectifier switch when the input voltage has a negative amplitude. In a first state, the power factor correction circuit is operated in a boundary conduction mode according to a current threshold. In a second state, the current threshold is adjusted, so that the boundary conduction mode is switched to a continuous conduction mode. In the boundary conduction mode and the continuous conduction mode, a next switching cycle starts when an inductor current flowing through the inductor reaches the current threshold.

### CROSS-REFERENCE TO RELATED APPLICATION

This application claims priority to China Patent Application No. 202510180430.4, filed on Feb. 18, 2025, the entire contents of which are incorporated herein by reference for all purposes.

### FIELD OF THE INVENTION

The present disclosure relates to the field of a circuit, and more particularly to a power factor correction circuit and a control method for the power factor correction circuit.

### BACKGROUND OF THE INVENTION

Generally, a power factor correction circuit is operated in a boundary conduction mode to turn on switches in a soft switching manner in order to reduce power loss and increase operating efficiency. However, if the input voltage is high enough and close to the output voltage (bulk voltage) and power factor correction circuit is continuously operated in the boundary conduction mode, the switching frequency is reduced, and thus ripples of the voltage and current at the input terminal of the power factor correction circuit become higher, and the overall control performance is unstable.

To overcome the drawbacks of the conventional technologies, it is important to provide an improved power factor correction circuit and a control method for the power factor correction circuit.

### SUMMARY OF THE INVENTION

The present disclosure provides a power factor correction circuit and a control method for the power factor correction circuit. When the power factor correction circuit is in a first state, the power factor correction circuit is operated in a boundary conduction mode. In a second state, the current threshold is adjusted, and the power factor correction circuit is controlled to be switched from the boundary conduction mode to a continuous conduction mode. In the boundary conduction mode and the continuous conduction mode, the next switching cycle is started when the inductor current flowing through the inductor reaches the current threshold. When compared with the conventional power factor correction circuit in the boundary conduction mode, the current ripple generated by the power factor correction circuit of the present disclosure is reduced, and the overall control performance is more stable. Especially, when the operation mode of the power factor correction circuit is switched between the boundary conduction mode and the continuous conduction mode, the smooth transition of the inductor current can be achieved. When compared with the boundary conduction mode, the switching frequency of the power factor correction circuit in the continuous conduction mode is increased, and the ripple of the current flowing through the inductor is reduced.

In accordance with an aspect of the present disclosure, a control method for a power factor correction circuit is provided. The power factor correction circuit receives an input voltage. The power factor correction circuit includes an inductor, a first upper switch and a first lower switch. The first lower switch is served as a main switch. The first upper switch is served as a rectifier switch when the input voltage has a positive amplitude. The first upper switch is served as the main switch. The first lower switch is served as the rectifier switch when the input voltage has a negative amplitude. When the power factor correction circuit is in a first state, the power factor correction circuit is controlled to be operated in a boundary conduction mode according to a current threshold. When the power factor correction circuit is in a second state, the current threshold is adjusted to switch the power factor correction circuit from the boundary conduction mode to a continuous conduction mode. In each of the boundary conduction mode and the continuous conduction mode, a next switching cycle starts when an inductor current flowing through the inductor reaches the current threshold.

In accordance with another aspect of the present disclosure, a power factor correction circuit is provided. The power factor correction circuit receives an input voltage from an input power source. The power factor correction circuit converts the input voltage into an output voltage. The output voltage is provided to a load. The power factor correction circuit includes a first bridge arm, an inductor and a controller. The first bridge arm includes a first upper switch and a first lower switch. The first upper switch and the first lower switch are connected with each other. A connection point between the first upper switch and the first lower switch is a first node. The first lower switch is served as a main switch. The first upper switch is served as a rectifier switch when the input voltage has a positive amplitude. The first upper switch is served as the main switch. The first lower switch is served as the rectifier switch when the input voltage has a negative amplitude. The inductor is connected between the input power source and the first node. When the power factor correction circuit is in a first state, the controller controls the power factor correction circuit to be operated in a boundary conduction mode according to a current threshold. When the power factor correction circuit is in a second state, the controller adjusts the current threshold to switch the power factor correction circuit from the boundary conduction mode to a continuous conduction mode. In each of the boundary conduction mode and the continuous conduction mode, a next switching cycle starts when an inductor current flowing through the inductor reaches the current threshold.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic circuit diagram illustrating the circuitry topology of a power factor correction circuit according to an embodiment of the present disclosure;

FIG. 2 is a schematic functional block diagram illustrating the control mechanism of the controller in the power factor correction circuit shown in FIG. 1;

FIG. 3 schematically illustrates the voltage loop control unit of the controller shown in FIG. 2;

FIG. 4A is a schematic timing sequence diagram illustrating a first implementation example of the operations of the power factor correction circuit;

FIG. 4B is a schematic timing sequence diagram illustrating a second implementation example of the operations of the power factor correction circuit;

FIG. 5 is a schematic timing waveform diagram illustrating the input voltage and the current threshold of the power factor correction circuit shown in FIG. 1; and

FIG. 6 is a flowchart illustrating a control method for the power factor correction circuit shown in FIG. 1.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

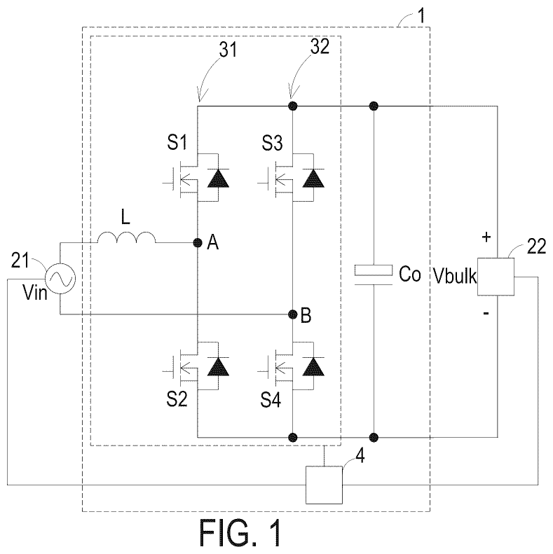

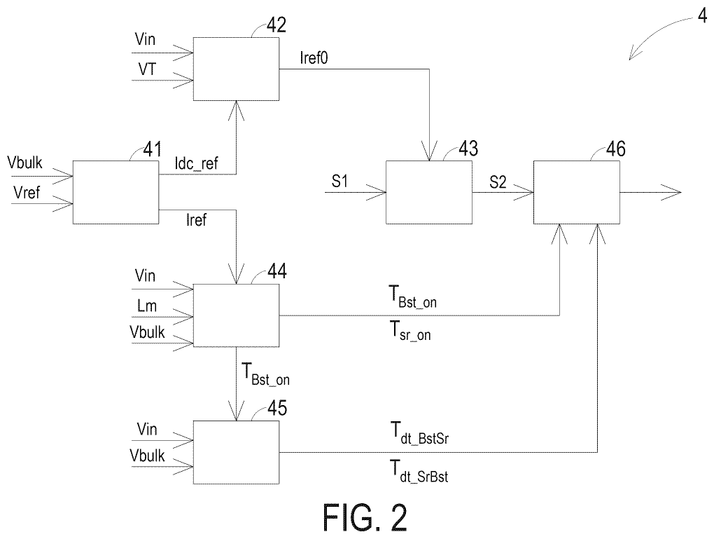

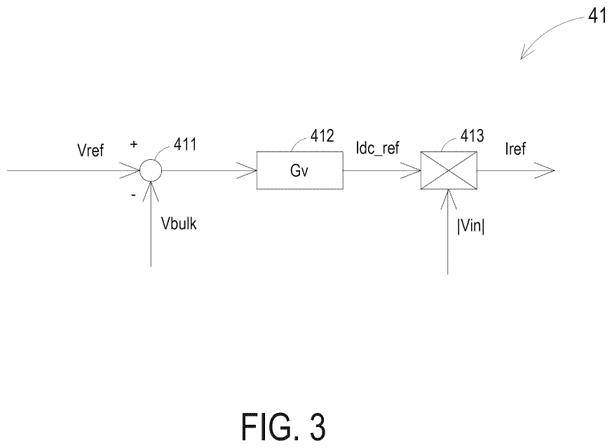

FIG. 1 is a schematic circuit diagram illustrating the circuitry topology of a power factor correction circuit according to an embodiment of the present disclosure. FIG. 2 is a schematic functional block diagram illustrating the control mechanism of the controller in the power factor correction circuit shown in FIG. 1. FIG. 3 schematically illustrates the voltage loop control unit of the controller shown in FIG. 2.

As shown in FIG. 1, the power factor correction circuit 1 receives an input voltage Vin from an input power source 21. After the input voltage Vin is converted into an output voltage Vbulk by the power factor correction circuit 1, the output voltage Vbulk is provided to a load 22. It is noted that the power factor correction circuit 1 has various topological structures. In this embodiment, the power factor correction circuit 1 is a totem pole power factor correction circuit. The power factor correction circuit 1 includes a first bridge arm 31, a second bridge arm 32, an output capacitor Co, an inductor L and a controller 4.

The first bridge arm 31 includes a first upper switch S1 and a first lower switch S2. The first upper switch S1 and the first lower switch S2 are connected with each other. The connection point between the first upper switch S1 and the first lower switch S2 is a first node A.

The second bridge arm 32 includes a second upper switch S3 and a second lower switch S4. The second upper switch S3 and the second lower switch S4 are connected with each other. The connection point between the second upper switch S3 and the second lower switch S4 is a second node B.

The inductor L is connected between the first terminal of the input power source 21 and the first node A. The second terminal of the input power source 21 is connected with the second node B.

The output capacitor Co is connected with the first bridge arm 31 and the second bridge arm 32 in parallel.

In an embodiment, the first upper switch S1 and the first lower switch S2 of the first bridge arm 31 are operated in a high-frequency chopping state, and the second upper switch S3 and the second lower switch S4 of the second bridge arm 32 are operating in a low-frequency working state (i.e., the switching frequency is the frequency of the input voltage Vin). For the first bridge arm 31, the first lower switch S2 served as a main switch and the first upper switch S1 served as a rectifier switch when the input voltage has a positive amplitude, and the first upper switch S1 served as a main switch and the first lower switch S2 served as the rectifier switch when the input voltage has a negative amplitude.

For the second bridge arm 32, the second upper switch S3 maintained in the turn-off state and the second lower switch S4 maintained in the turn-on state when the input voltage has the positive amplitude, and the second upper switch S3 maintained in the turn-on state and the second lower switch S4 maintained in the turn-off state when the input voltage has the negative amplitude.

In some embodiments, the second upper switch S3 and the second lower switch S4 are implemented with diodes.

In accordance with the feature of the present disclosure, the working state of the second bridge arm 32 is not affected by the mode switching action. For brevity, only the switching states of the first upper switch S1 and the first lower switch S2 of the first bridge arm 31 will be described as follows, and the states of the second upper switch S3 and the second lower switch S4 of the second bridge arm 32 will not be described. For illustration, in the following embodiments, the input voltage is an AC voltage in a positive half cycle. When the power factor correction circuit 1 is in a first state, the controller 4 controls the power factor correction circuit 1 to be operated in a boundary conduction mode. When the power factor correction circuit 1 is switched from the first state to a second state, the controller 4 adjusts an internal current threshold Iref0 to switch the power factor correction circuit 1 from the boundary conduction mode to a continuous conduction mode. . . . When compared with the boundary conduction mode, the switching frequency of the power factor correction circuit 1 in the continuous conduction mode is increased, and the ripple of the current flowing through the inductor L is reduced. It should be understood that there are various conditions for switching the operation mode of the power factor correction circuit 1 from the boundary conduction mode to the continuous conduction mode, i.e., the transition from the first state to the second state. For example, the controller 4 detects the input voltage Vin of the power factor correction circuit 1. If the input voltage Vin is lower than or equal to a first threshold VT, the controller 4 confirms that the power factor correction circuit 1 is in the first state. If the input voltage Vin exceeds the first threshold VT, the controller 4 confirms that the power factor correction circuit 1 is switched from the first state to the second state. That is, under control of the controller 4, the power factor correction circuit 1 is switched from the boundary conduction mode to the continuous conduction mode. In an embodiment, the first threshold VT is set as a half of the output voltage Vbulk.

Alternatively, the controller 4 detects the switching frequency of the power factor correction circuit 1. If the switching frequency is higher than or equal to a second threshold, the controller 4 confirms that the power factor correction circuit 1 is in the first state. If the switching frequency is lower than the second threshold, the controller 4 confirms that the power factor correction circuit 1 is in the second state.

Alternatively, the controller 4 detects the ripple of the inductor current flowing through the inductor L. If the ripple of the inductor current is lower than or equal to a third threshold, the controller 4 confirms that the power factor correction circuit 1 is in the first state. If the ripple of the inductor current exceeds the third threshold, the controller 4 confirms that the power factor correction circuit 1 is in the second state.

Of course, these three switching conditions can also be used in combination.

The conduction time of the main switch and the conduction time of the rectifier switch in the first bridge arm 31 can be obtained through theoretical calculations. Furthermore, when the inductor current flowing through the inductor L reaches the current threshold Iref0, the next switching cycle starts.

In an embodiment, when the inductor current reaches the current threshold Iref0, the main switch of the power factor correction circuit 1 is turned on to start the next switching cycle. However, in boundary conduction mode, a delay time is usually required to achieve the soft turn-on function of the main switch. The main switch is turned on when the inductor current rises from a negative value to the current threshold.

In another embodiment, for correcting the switching timing in each switching cycle of the main switch and avoiding the accumulation of calculation errors, the conduction time of the main switch in the power factor correction circuit 1 is re-counted to start the next switching cycle when the inductor current reaches the current threshold Iref0. That is, the portion of conduction time before the inductor current reaches the current threshold Iref0 is not included in the conduction time of the main switch for theoretical calculation.

However, in the boundary conduction mode, a delay time is usually required to achieve the soft turn-on function of the main switch. For example, the main switch is turned on when the inductor current rises from a negative value to the current threshold, or the main switch is turned on at the end of the delay time. Furthermore, the conduction time of the main switch is re-counted when the inductor current rises from the negative value to the current threshold, and the main switch is turned off when its conduction time reaches a first preset time.

In the boundary conduction mode, the current threshold Iref0 is set to zero. In the continuous conduction mode, the current threshold Iref0 is configured to be in phase with the real-time sampled input voltage Vin when the input voltage Vin has the positive amplitude and in phase with an inverted signal of the input voltage Vin when the input voltage Vin has the negative amplitude, and the current threshold Iref0 is increased from zero. For example, the current threshold Iref0 is set to be positively correlated with the difference between the real-time sampled input voltage Vin and the first threshold VT, wherein VT is the sampled value of the input voltage Vin at the moment of switching from the boundary conduction mode to the continuous conduction mode. Since the Iref0 remains zero before and after the mode switching process, the smooth switching purpose can be achieved. In addition, the magnitude of the current threshold Iref0 gradually increases with the increasing loading of the load 22.

Hereinafter, the components of the controller 4 and the control method for the controller 4 will be described according to the result of comparing the input voltage Vin with the first threshold VT.

Please refer to FIG. 2 and FIG. 3. The controller 4 includes a voltage loop control unit 41, a current threshold generating unit 42, an inductor current detecting unit 43, a conduction time control unit 44 and a switch control unit 46.

The voltage loop control unit 41 includes a subtractor 411, a compensator 412 and a multiplier 413. The subtractor 411 of the voltage loop control unit 41 receives an output voltage Vbulk and a reference voltage Vref. The reference voltage Vref represents an expected value of the output voltage Vbulk. The subtractor 411 generates an error between the output voltage Vbulk and the reference voltage Vref. The compensator 412 of the voltage loop control unit 41 performs compensation according to the error between the output voltage Vbulk and the reference voltage Vref and generates a first reference current Idc_ref. The multiplier 413 of the voltage loop control unit 41 obtains a second reference current Iref according to the multiplication result of the first reference current Idc_ref and the absolute value of the input voltage Vin. In an embodiment, the second reference current Iref has a steamed bun waveform, which represents the average value of the inductor current flowing through the inductor L.

The current threshold generating unit 42 is configured to generate a corresponding current threshold Iref0 according to the result of comparing the input voltage Vin and the preset first threshold VT and the first reference current Idc_ref from the voltage loop control unit 41. If the input voltage Vin is lower than or equal to the first threshold VT and the power factor correction circuit 1 is operated in the boundary conduction mode, the current threshold generating unit 42 configures the current threshold Iref0 to be 0. If the input voltage Vin is higher than the first threshold VT and the power factor correction circuit 1 operates in the continuous conduction mode, the current threshold generating unit 42 configures the current threshold Iref0 to be positively correlated with the difference between the input voltage Vin and the first threshold VT. Furthermore, in the continuous conduction mode, the current threshold Iref0 is positively correlated with the first reference current Idc_ref, and the first reference current Idc_ref is related to the loading of the load 22. For example, the current threshold in the continuous conduction mode may be expressed as formula (1):

$$Iref 0 = k \times Idc\_ref \times ( \vert Vin \vert - VT ) \qquad ( 1 )$$

In the formula (1), Iref0 is the current threshold, k is a constant, Idc_ref is the first reference current, Vin is the input voltage, and VT is the first threshold.

In an embodiment, the first threshold VT is ½ of the output voltage Vbulk. When the input voltage Vin reaches ½ of the output voltage Vbulk, the boundary conduction mode is switched to the continuous conduction mode. When compared with the boundary conduction mode, the current ripple of the power factor correction circuit 1 in the continuous conduction mode is reduced, and the switching frequency is increased.

The inductor current detection unit 43 includes a first terminal, a second terminal and a third terminal. The first terminal of the inductor current detection unit 43 receives a sampling signal S1 representing the inductor current of the inductor L. The second terminal of the inductor current detection unit 43 receives the current threshold Iref0 from the current threshold generating unit 42. The inductor current detection unit 43 determines whether the sampling signal S1 representing the inductor current of the inductor L reaches the current threshold Iref0, and the third terminal of the inductor current detection unit 43 outputs a confirmation signal S2 according to the determining result.

The conduction time control unit 44 receives the input voltage Vin, the output voltage Vbulk, the inductance Lm of the inductor L and the second reference current Iref and generates a first preset time T_{Bst_on} and a second preset time T_{sr_on}. When the power factor correction circuit 1 is operated in the boundary conduction mode, the first preset time T_{Bst_on} is configured to be correlated with the input voltage Vin, the inductance Lm of the inductor L and the difference between the second reference current Iref and the current threshold Iref0 by the conduction time control unit 44. For example, the first preset time T_{Bst_on} is configured to be negatively correlated with the absolute value of the input voltage Vin, and the first preset time T_{Bst_on} is configured to be positively correlated with the inductance Lm of the inductor L and the second reference current Iref. For example, when the power factor correction circuit 1 is operated in the continuous conduction mode, the first preset time T_{Bst_on} is configured to be negatively correlated with the absolute value of the input voltage Vin, and the first preset time T_{Bst_on} is configured to be positively correlated with the inductance Lm of the inductor L and the difference between the second reference current Iref and the current threshold Iref0 by the conduction time control unit 44.

For example, the first preset time is expressed as the following formula (2) in the boundary conduction mode, and the first preset time is expressed as the following formula (3) in the continuous conduction mode:

$${T}_{Bst \_ on} = {T}_{Bst \_ on 1} = \frac{2 Iref * Lm}{\vert V i n \vert} \qquad ( 2 )$$

$${T}_{Bst \_ on} = {T}_{Bst \_ on 2} = \frac{2 ( Iref - k * Idc\_ref * ( \vert V i n \vert - V T ) ) * L m}{\vert V i n \vert} \qquad ( 3 )$$

In the above formulas, T_{Bst_on1} is the first preset time in the boundary conduction mode, and T_{Bst_on2} is the first preset time in the continuous conduction mode.

When the power factor correction circuit 1 is operated in the boundary conduction mode, the second preset time T_{sr_on} is configured to be correlated with the first preset time T_{Bst_on1}, the input voltage Vin and the output voltage Vbulk by the conduction time control unit 44. For example, in the boundary conduction mode, the second preset time T_{sr_on} is configured to be positively correlated with the first preset time T_{Bst_on1} and the absolute value of the input voltage Vin, and negatively correlated with the correlated with the difference between the output voltage Vbulk and the absolute value of the input voltage Vin. When the power factor correction circuit 1 is operated in the continuous conduction mode, the second preset time T_{sr_on} is configured to be correlated with the first preset time T_{Bst_on2} and the absolute value of the input voltage Vin, and negatively correlated with the difference between the output voltage Vbulk and the absolute value of the input voltage Vin.

For example, the second preset time is expressed as the following formula (4) in the boundary conduction mode, and the second preset time is expressed as the following formula (5) in the continuous conduction mode:

$${T}_{sr \_ on} = {T}_{{sr}_{- o n 1}} = {T}_{Bst \_ on 1} \frac{\vert V i n \vert}{V b u l k - \vert V i n \vert} \qquad ( 4 )$$

$${T}_{sr \_ on} = {T}_{{sr}_{- on 2}} = {T}_{Bst \_ on 2} \frac{\vert V i n \vert}{V b u l k - \vert V i n \vert} \qquad ( 5 )$$

In the above formulas, T_{sr_on1} is the second preset time in the boundary conduction mode, T_{sr_on2} is the second preset time in the continuous conduction mode, and Vbulk is the output voltage.

The switch control unit 46 receives the confirmation signal S2 from the third terminal of the inductor current detection unit 43 and receives the first preset time T_{Bst_on} and the second preset time T_{sr_on} from the conduction time control unit 44. The switch control unit 46 controls the main switch to be turned on according to the confirmation signal S2, or the switch control unit 46 recounts the conduction time of the main switch according to the confirmation signal S2 (in this case, the main switch is turned on after the rectifier switch is turned off). In addition, the switch control unit 46 turns off the main switch when the conduction time of the main switch reaches the first preset time T_{Bst_on}. In addition, the switch control unit 46 controls the rectifier switch to be turned on after the main switch is turned off, and the switch control unit 46 turns off the rectifier switch when the on-time of the rectifier switch reaches the second preset time T_{sr_on}.

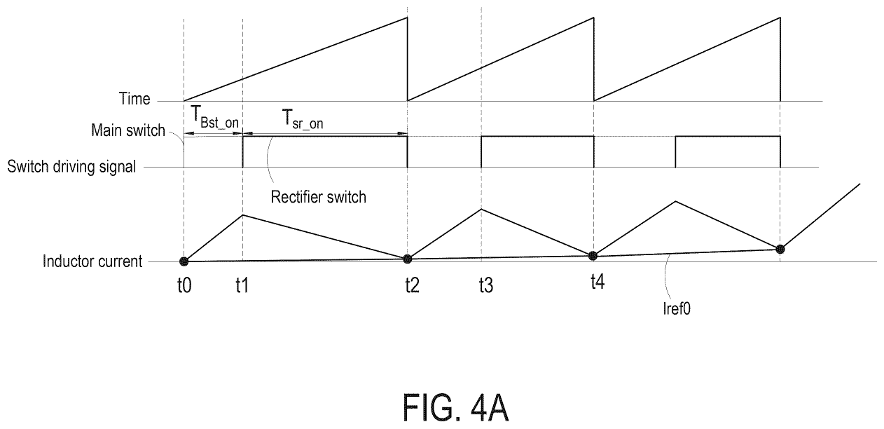

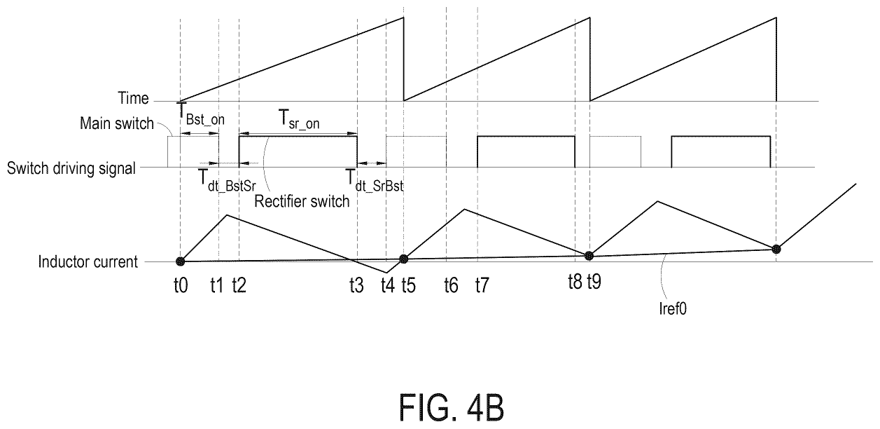

In the normal condition, when the inductor current reaches the current threshold Iref0, the main switch is turned on or the conduction time of the main switch is re-counted to start the next switching cycle. Please refer to FIG. 4A in conjunction with FIGS. 1, 2 and 3. FIG. 4A is a schematic timing sequence diagram illustrating a first implementation example of the operations of the power factor correction circuit.

When the input voltage Vin is lower than the first threshold VT and the power factor correction circuit 1 is operated in the boundary conduction mode, at the time point to, the inductor current reaches the current threshold Iref0, and the main switch is turned on. When the conduction time of the main switch reaches the first preset time T_{Bst_on} (=T_{Bst_on1}), i.e., at the time point t1, the main switch is turned off and the rectifier switch is turned on, and the inductor current flowing through the inductor L begins to decrease. When the conduction time of the rectifier switch reaches the second preset time T_{sr_on} (=T_{sr_on1}), i.e., at the time point t2, the rectifier switch is turned off. Ideally, the conduction time of the rectifier switch is accurately calculated to match the moment when the inductor current drops to the current threshold.

In a variant example, the main switch is turned on after the rectifier switch is turned off, but its conduction time is not counted at this time. At the time point to, the inductor current reaches the current threshold Iref0, and the conduction time of the main switch starts to be re-counted from zero. In this way, the error accumulation of the calculation errors of the multiple cycles in actual applications will be eliminated. When the conduction time of the main switch reaches the first preset time T_{Bst_on} (=T_{Bst_on1}), i.e., at the time point t1, the main switch is turned off and the rectifier switch is turned on, and the inductor current flowing through the inductor L begins to decrease. When the conduction time of the rectifier switch reaches the second preset time T_{sr_on} (=T_{sr_on1}), i.e., at the time point t2, the rectifier switch is turned off and the main switch is turned on. In addition, the inductor current flowing through the inductor L increases. At the time point t2, the input voltage Vin is higher than the first threshold VT, and thus the power factor correction circuit 1 is switched to the continuous conduction mode. When the conduction time of the main switch or the counted conduction time of the main switch reaches the first preset time T_{Bst_on} (=T_{Bst_on2}), i.e., at the time point t3, the main switch is turned off and the rectifier switch is turned on, and the inductor current begins to decrease. When the conduction time of the rectifier switch reaches the second preset time T_{sr_on} (=T_{sr_on2}), i.e., at the time point t4, the rectifier switch is turned off. When the inductor current decreases to the current threshold Iref0 in the continuous conduction mode, the main switch is turned on, or the conduction time of the main switch is re-counted. Of course, in order to prevent the main switch and the rectifier switch from being directly connected, a dead time is usually inserted into the switching sequence. That is, the rectifier switch is turned on after the main switch is turned off for the dead time, and the main switch is turned on after the rectifier switch is turned off for the dead time. The setting of the dead time is known to those skilled in the art, and not redundantly described herein.

Alternatively, in the boundary conduction mode, an additional delay time is added after the rectifier switch is turned off. In this way, the soft switching function of the main switch can be achieved. Since the delay time is added to the switching cycle, the inductor current will become negative and then rise to a positive value. When the inductor current rises from a negative value to the current threshold, the confirmation signal S2 is valid and the next switching cycle is started.

In an embodiment, the controller 4 further includes a delay time generating unit 45. The delay time generating unit 45 receiving the first preset time T_{Bst_on} from the conduction time control unit 44 and receives the input voltage Vin and the output voltage Vbulk. In addition, the delay time generating unit 45 generates a delay time T_{dt_SrBst}.

The switch control unit 46 receives the confirmation signal S2 from the third terminal of the inductor current detection unit 43, the first preset time T_{Bst_on} and the second preset time T_{sr_on} from the conduction time control unit 44 and the delay time T_{dt_SrBst} from the delay time generation unit 45. For example, under control of the switch control unit 46, the main switch is directly turned on according to the confirmation signal S2, and the main switch is turned off when the conduction time of the main switch reaches the first preset time T_{Bst_on}. Alternatively, the switch control unit 46 re-counts the conduction time of the main switch according to the confirmation signal S2. In addition, the switch control unit 46 controls the main switch to be turned on after the rectifier switch has been turned off for the delay time T_{dt_SrBst}, and the switch control unit 46 controls the main switch to be turned off when the counted conduction time of the main switch reaches the first preset time T_{Bst_on}. Afterwards, the switch control unit 46 controls the rectifier switch to be turned on after the main switch has been turned off for a dead time, and the switch control unit 46 controls the rectifier switch to be turned off when the conduction time of the rectifier switch reaches the second preset time T_{sr_on}.

Another implementation example of the operations of the power factor correction circuit 1 will be described as follows. In this embodiment, an additional delay time is added. FIG. 4B is a schematic timing sequence diagram illustrating a second implementation example of the operations of the power factor correction circuit. When the inductor current rises from negative to the current threshold Iref0, the conduction time of the main switch is re-counted. Please refer to FIG. 4B in conjunction with FIGS. 1, 2 and 3.

In the implementation example of FIG. 4B, the input voltage Vin is higher than zero. When the input voltage Vin is lower than the first threshold VT and the power factor correction circuit 1 is operated in the boundary conduction mode, the current threshold Iref0 is zero. The main switch is turned on before the time point to, but the inductor current has not reached the current threshold Iref. That is, the timing of counting the conduction time of the main switch is not started. At the time point to when the inductor current reaches the current threshold Iref0, the timing of counting the conduction time of the main switch is started. When the conduction time of the main switch reaches the first preset time T_{Bst_on} (=T_{Bst_on1}), i.e., at the time point t1, the main switch is turned off. When the duration of the main switch in the turn-off state reaches the dead time T_{dt_BstSr}, i.e., at the time point t2, the rectifier switch is turned on, and the inductor current flowing through the inductor L decreases. When the conduction time of the rectifier switch reaches the second preset time T_{sr_on} (=T_{sr_on1}), i.e., at the time point t3, the rectifier switch is turned off. Afterwards, the inductor current flowing through the inductor L continuously decreases to a negative value. When the duration of the rectifier switch in the turn-off state reaches the delay time T_{dt_SrBst}, i.e., at the time point t4, the main switch is turned on again at the end of the delay time, and the inductor current flowing through the inductor L increases. Meanwhile, the inductor current flows through the body diode of the main switch. However, the conduction time of the main switch is not counted at this moment. At the time point t5, the inductor current flowing through the inductor L rises from a negative value to the current threshold Iref0, the conduction time of the main switch is recounted. In one switching cycle (i.e., in the time interval between the time point to and the time point t5), the main switch and the rectifier switch are turned on once respectively.

At the time point t5, the input voltage Vin is higher than the first threshold VT, and thus the power factor correction circuit 1 is switched to the continuous conduction mode. When the conduction time of the main switch or the counted conduction time of the main switch reaches the first preset time T_{Bst_on} (=T_{Bst_on2}), i.e., at the time point t6, the main switch is turned off. After the dead time, i.e., at the time point t7, the rectifier switch is turned on and the inductor current decreases. When the conduction time of the rectifier switch reaches the second preset time T_{sr_on} (=T_{sr_on2}), i.e., at the time point t8, the rectifier switch is turned off. Then, at the time point t9, the dead time is ended, and the main switch is turned on again. When the inductor current decreases to the current threshold Iref0, the conduction time of the main switch is re-counted.

In the ideal situation, the time point when the main switch is turned on and the time point when the inductor current drops to the current threshold Iref0 overlap with each other. In the continuous conduction mode, the main switch is turned on when the inductor current is higher than zero. Consequently, there is no need to set a delay time, and only the setting of the dead time is needed. Furthermore, in the continuous conduction mode, the conduction time of the main switch (i.e., the first preset time) and the conduction time of the rectifier switch (i.e., the second preset time) are also correspondingly changed. As can be seen from the drawing, the valley value of the inductor current is lower than or equal to zero in the boundary conduction mode, and the valley value of the inductor current is higher than zero in the continuous conduction mode.

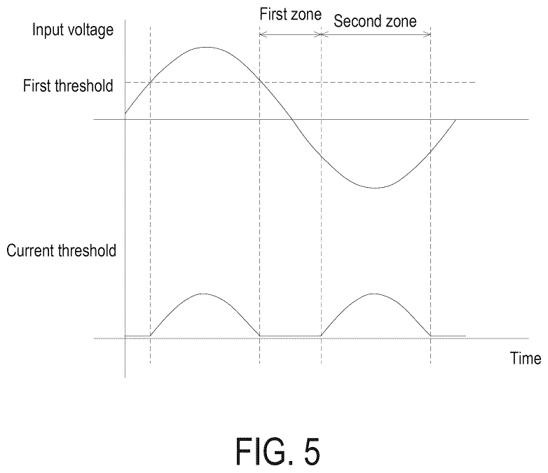

FIG. 5 is a schematic timing waveform diagram illustrating the inductor current and the current threshold of the power factor correction circuit shown in FIG. 1. When the absolute value of the input voltage Vin is lower than or equal to the first threshold VT, i.e., in the first zone, the controller 4 confirms that the power factor correction circuit 1 is operated in the boundary conduction mode. When the absolute value of the input voltage Vin is higher than the first threshold VT, i.e., in a second zone, the controller 4 confirms that the power factor correction circuit 1 is operated in the continuous conduction mode. When the operation mode of the power factor correction circuit 1 is switched between the boundary conduction mode and the continuous conduction mode, the smooth transition of the inductor current can be achieved. As shown in FIG. 5, the current threshold Iref0 is zero in the first zone, and the current threshold Iref0 is higher than zero in the second zone. Furthermore, in the second zone, the current threshold Iref0 is increased from zero to achieve the smooth switching efficacy, and the current threshold Iref0 is in phase with the absolute value of the input voltage.

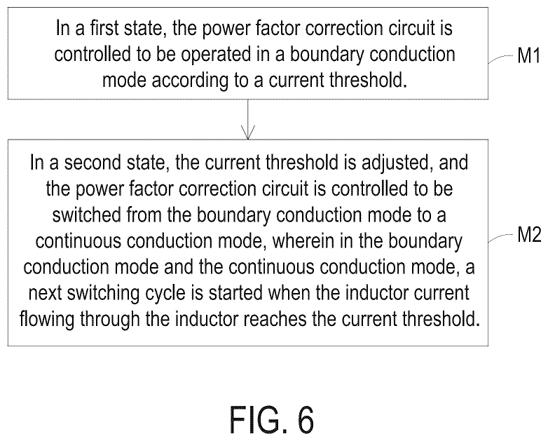

FIG. 6 is a flowchart illustrating a control method for the power factor correction circuit shown in FIG. 1. Firstly, in a first state, the power factor correction circuit 1 is controlled to be operated in a boundary conduction mode according to a current threshold Iref0 (Step M1). Then, in a second state, the current threshold Iref0 is adjusted, and the power factor correction circuit 1 is controlled to be switched from the boundary conduction mode to a continuous conduction mode (Step M2). In the boundary conduction mode and the continuous conduction mode, a next switching cycle is started when the inductor current flowing through the inductor L reaches the current threshold Iref0.

From the above descriptions, the present disclosure provides a power factor correction circuit and a control method for the power factor correction circuit. When the power factor correction circuit is in a first state, the power factor correction circuit is operated in a boundary conduction mode. In a second state, the current threshold is adjusted, and the power factor correction circuit is controlled to be switched from the boundary conduction mode to a continuous conduction mode. In the boundary conduction mode and the continuous conduction mode, the next switching cycle is started when the inductor current flowing through the inductor reaches the current threshold. When compared with the conventional power factor correction circuit in the boundary conduction mode, the current ripple generated by the power factor correction circuit of the present disclosure is reduced, and the overall control performance is more stable. Especially, when the operation mode of the power factor correction circuit is switched between the boundary conduction mode and the continuous conduction mode, the smooth transition of the inductor current can be achieved. When compared with the boundary conduction mode, the switching frequency of the power factor correction circuit in the continuous conduction mode is increased, and the ripple of the current flowing through the inductor is reduced.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A control method for a power factor correction circuit, the power factor correction circuit receiving an input voltage, the power factor correction circuit comprising an inductor, a first upper switch and a first lower switch, the first lower switch being served as a main switch and the first upper switch being served as a rectifier switch when the input voltage has a positive amplitude, the first upper switch being served as a main switch and the first lower switch being served as the rectifier switch when the input voltage has a negative amplitude, the control method comprising steps of:
when the power factor correction circuit is in a first state, controlling the power factor correction circuit to be operated in a boundary conduction mode according to a current threshold; and
when the power factor correction circuit is in a second state, adjusting the current threshold to switch the power factor correction circuit from the boundary conduction mode to a continuous conduction mode,
wherein in each of the boundary conduction mode and the continuous conduction mode, a next switching cycle starts when an inductor current flowing through the inductor reaches the current threshold.

2. The control method according to claim 1, further comprising a step of detecting the input voltage, wherein when an absolute value of the input voltage is lower than or equal to a first threshold, the power factor correction circuit is in the first state, wherein when the absolute value of the input voltage is higher than the first threshold, the power factor correction circuit is in the second state.

3. The control method according to claim 2, wherein the first threshold is a half of an output voltage from the power factor correction circuit.

4. The control method according to claim 1, further comprising a step of detecting a switching frequency of the power factor correction circuit, wherein when the switching frequency is higher than or equal to a second threshold, the power factor correction circuit is in the first state, wherein when the switching frequency is lower than the second threshold, the power factor correction circuit is in the second state.

5. The control method according to claim 1, further comprising a step of detecting a ripple of the inductor current, wherein when the ripple of the inductor current is lower than or equal to a third threshold, the power factor correction circuit is in the first state, wherein when the ripple of the inductor current is higher than the third threshold, the power factor correction circuit is in the second state.

6. The control method according to claim 1, wherein when the power factor correction circuit is operated in the boundary conduction mode, the current threshold is set to zero, wherein when the power factor correction circuit is operated in the continuous conduction mode and the input voltage has the positive amplitude, the current threshold is in phase with the input voltage, wherein when the power factor correction circuit is operated in the continuous conduction mode and the input voltage has the negative amplitude, the current threshold is in phase with an inverted signal of the input voltage, and the current threshold is increased from zero.

7. The control method according to claim 6, wherein the power factor correction circuit is connected with a load, wherein in the continuous conduction mode, a magnitude of the current threshold gradually increases with an increasing loading of the load.

8. The control method according to claim 6, wherein in the continuous conduction mode, the current threshold is positively correlated with a difference between the input voltage and a first threshold, and the first threshold is a value of the input voltage sampled at a moment of switching from the boundary conduction mode to the continuous conduction mode.

9. The control method according to claim 8, further comprising:
compensating an error between an output voltage of the power factor correction circuit and a reference voltage represents an expected value of the output voltage to generate a first reference current, wherein in the continuous conduction mode, the current threshold is positively correlated with the first reference current and the difference between the input voltage and the first threshold.

10. The control method according to claim 1, wherein when the inductor current reaches the current threshold, the main switch is turned on or a conduction time of the main switch is re-counted, so that the next switching cycle starts.

11. The control method according to claim 10, wherein in the boundary conduction mode, the main switch is turned on after the rectifier switch has been turned off for a delay time, so that the main switch is turned on in a soft switching manner, wherein the main switch is turned on when the inductor current rises from a negative value to the current threshold, or the main switch is turned on at an end of the delay time and a conduction time of the main switch is re-counted when the inductor current rises from the negative value to the current threshold, and the main switch is turned off when the conduction time of the main switch reaches a first preset time, wherein the rectifier switch is turned on after the main switch is turned off, and the rectifier switch is turned off when a conduction time of the rectifier switch reaches a second preset time.

12. The control method according to claim 10, wherein in the continuous conduction mode, the main switch is turned on after the rectifier switch has been turned off for a dead time, wherein the main switch is turned on when the inductor current decreases to the current threshold, or the main switch is turned on after the rectifier switch has been turned off for the dead time and a conduction time of the main switch is re-counted when the inductor current decreases to the current threshold, and the main switch is turned off when the conduction time of the main switch reaches a first preset time, wherein the rectifier switch is turned on after the main switch is turned off, and the rectifier switch is turned off when a conduction time of the rectifier switch reaches a second preset time.

13. The control method according to claim 11, wherein the first preset time is correlated with the input voltage, an inductance of the inductor and a difference between a second reference current and the current threshold, the second reference current represents an average value of the inductor current, and the second preset time is correlated with the first preset time, the input voltage and an output voltage of the power factor correction circuit.

14. A power factor correction circuit configured to receive an input voltage from an input power source and convert the input voltage into an output voltage to be provided to a load, the power factor correction circuit comprising:
a first bridge arm comprising a first upper switch and a first lower switch, wherein the first upper switch and the first lower switch are connected with each other, and a connection point between the first upper switch and the first lower switch is a first node, wherein the first lower switch is served as a main switch and the first upper switch is served as a rectifier switch when the input voltage has a positive amplitude, and the first upper switch is served as the main switch and the first lower switch is served as the rectifier switch when the input voltage has a negative amplitude;
an inductor connected between the input power source and the first node;
a controller, wherein when the power factor correction circuit is in a first state, the controller controls the power factor correction circuit to be operated in a boundary conduction mode according to a current threshold, wherein when the power factor correction circuit is in a second state, the controller adjusts the current threshold to switch the power factor correction circuit from the boundary conduction mode to a continuous conduction mode,
wherein in each of the boundary conduction mode and the continuous conduction mode, a next switching cycle starts when an inductor current flowing through the inductor reaches the current threshold.

15. The power factor correction circuit according to claim 14, wherein the controller detects the input voltage, wherein when an absolute value of the input voltage is lower than or equal to a first threshold, the power factor correction circuit is in the first state, wherein when the absolute value of the input voltage is higher than the first threshold, the power factor correction circuit is in the second state.

16. The power factor correction circuit according to claim 14, wherein the controller detects a switching frequency of the power factor correction circuit, wherein when the switching frequency is higher than or equal to a second threshold, the power factor correction circuit is in the first state, wherein when the switching frequency is lower than the second threshold, the power factor correction circuit is in the second state.

17. The power factor correction circuit according to claim 14, wherein the controller detects a ripple of the inductor current, wherein when the ripple of the inductor current is lower than or equal to a third threshold, the power factor correction circuit is in the first state, wherein when the ripple of the inductor current is higher than the third threshold, the power factor correction circuit is in the second state.

18. The power factor correction circuit according to claim 14, wherein the controller further comprises a current threshold generating unit, wherein when the power factor correction circuit is operated in the boundary conduction mode, the current threshold is set to zero by the current threshold generating unit, wherein when the power factor correction circuit is operated in the continuous conduction mode, the current threshold is in phase with the input voltage when the input voltage has the positive amplitude and in phase with an inverted signal of the input voltage when the input voltage has the negative amplitude, and the current threshold is increased from zero under control of the current threshold generating unit.

19. The power factor correction circuit according to claim 18, wherein when the power factor correction circuit is operated in the continuous conduction mode, a magnitude of the current threshold gradually increases with an increasing loading of the load under control of the current threshold generating unit.

20. The power factor correction circuit according to claim 18, wherein in the continuous conduction mode, the current threshold is positively correlated with a difference between the input voltage and a first threshold under control of the current threshold generating unit, the first threshold is a value of the input voltage sampled at a moment of switching from the boundary conduction mode to the continuous conduction mode.

21. The power factor correction circuit according to claim 20, wherein the controller further comprises a voltage loop control unit, and the voltage loop control unit receives an output voltage and a reference voltage representing an expected value of the output voltage, wherein after an error between the output voltage and the reference voltage is compensated, the voltage loop control unit generates a first reference current, wherein in the continuous conduction mode, the current threshold is positively correlated with the first reference current and the difference between the input voltage and the first threshold under control of the current threshold generating unit.

22. The power factor correction circuit according to claim 18, wherein when the inductor current reaches the current threshold, the main switch is turned on or a conduction time of the main switch is re-counted to start the next switching cycle.

23. The power factor correction circuit according to claim 22, wherein the controller further comprises a conduction time control unit and a switch control unit, wherein the conduction time control unit generates a first preset time and a second preset time, and the switch control unit controls turn-on/turn-off states of the main switch and the rectifier switch,
wherein in the boundary conduction mode, the main switch is turned on after the rectifier switch has been turned off for a delay time, so that the main switch is turned on in a soft switching manner, wherein the main switch is turned on when the inductor current rises from a negative value to the current threshold, or the main switch is turned on at an end of the delay time and a conduction time of the main switch is re-counted when the inductor current rises from the negative value to the current threshold, and the main switch is turned off when the conduction time of the main switch reaches the first preset time, wherein the rectifier switch is turned on after the main switch is turned off, and the rectifier switch is turned off when a conduction time of the rectifier switch reaches the second preset time,
wherein in the continuous conduction mode, the main switch is turned on after the rectifier switch has been turned off for a dead time, wherein the main switch is turned on when the inductor current decreases to the current threshold, or the main switch is turned on after the rectifier switch has been turned off for the dead time and the conduction time of the main switch is re-counted when the inductor current decreases to the current threshold, and the main switch is turned off when the conduction time of the main switch reaches the first preset time, wherein the rectifier switch is turned on after the main switch is turned off, and the rectifier switch is turned off when the conduction time of the rectifier switch reaches the second preset time.

24. The power factor correction circuit according to claim 14, wherein the power factor correction circuit further comprises a second bridge arm, and the second bridge arm comprises a second upper switch and a second lower switch, wherein the second upper switch and the second lower switch are connected with each other, and a connection point between the second upper switch and the second lower switch is a second node, wherein the second node is connected with the input power source.
